(19) United States
(12) Patent Application Publication
(10) Pub. No.: US 2018/0037280 A1
(43) Pub. Date: Feb. 8, 2018

(54) TRACK SHOE

(71) Applicant: Caterpillar Global Mining LLC, Tucson, AZ (US)

(72) Inventor: Udo Nott, Herdecke (DE)

(73) Assignee: Caterpillar Global Mining LLC, Tucson, AZ (US)

(21) Appl. No.: 15/557,225

(22) PCT Filed: Mar. 15, 2016
(86) PCT No.: PCT/US2016/022406

§ 371 Date: Sep. 11, 2017

(30) Foreign Application Priority Data
Mar. 20, 2015 (DE) 202015002177.8

(51) Int. Cl. B62D 55/21

(52) U.S. Cl. CPC B62D 55/21; B62D 55/06

(57) ABSTRACT

A track shoe for a track of a large hydraulic excavator comprises a plate-shaped base having a substantially rectangular base surface and being defined in a circumferential direction by a left side surface, a right side surface, a front surface and a rear surface. The front surface and the rear surface include a front stopper and a rear stopper, respectively. The front stopper and the rear stopper limit a negative rotation of adjacent track shoes in the track to a predetermined angle.

### TECHNICAL FIELD

The present disclosure generally relates to track vehicles, and in particular to a track shoe.

### BACKGROUND

Track vehicles, for example, large hydraulic excavators, generally include a drive unit having a drive sprocket and one or more idlers or rollers for guiding the track. The track includes a plurality of track links, generally referred to as shoes, connected to each other by pins. These shoes support the weight of the associated machine as the machine travels on the ground.

DE 10 2011 012 711 B3 discloses an example of a crawler drive including a drive sprocket, an idler, a plurality of rollers, a plurality of belt-tighteners and an endless track formed by a plurality of pivotally connected track shoes.

The present systems and methods are directed at least in part to improving known systems.

### SUMMARY OF THE DISCLOSURE

In one aspect, the present disclosure relates to a track shoe for a track, in particular, a track of a large hydraulic excavator, comprising a plate-shaped base having a substantially rectangular base surface and being defined in a circumferential direction by a left side surface, a right side surface, a front surface, and a rear surface. A first connecting portion is disposed on the base and protrudes from the front surface. A second connecting portion is disposed on the base and protrudes from the rear surface. The second connecting portion is configured for connecting to the first connecting portion of another identically formed track shoe such that it is rotatable with respect to the track shoe about an axis of rotation. The front surface and the rear surface comprise a front stopper and a rear stopper, respectively, configured such that, upon rotation, the rear stopper of the track shoe abuts against the front stopper of the other track shoe to limit the rotation to a predetermined angle.

In another aspect, the present disclosure relates to a track shoe for a track, in particular, a track of a large hydraulic excavator, comprising a plate-shaped base having a substantially rectangular base surface and being defined in a transverse direction by a left side surface and a right side surface and in a longitudinal direction by a front surface and a rear surface. A first connecting portion is disposed on the base and protrudes from the front surface. A second connecting portion is disposed on the base and protrudes from the rear surface. The second connecting portion is configured for connecting to the first connecting portion of another identically formed track shoe. The front surface and the rear surface comprise a front stopper having a front stopper surface and a rear stopper having a rear stopper surface, respectively. The front stopper surface and the rear stopper surface are each disposed at an angle of less than 90° with respect to the base surface.

In a further aspect, the present disclosure relates to a track shoe for a track, in particular, a track of a large hydraulic excavator, comprising a plate-shaped base having a substantially rectangular base surface and being defined in a transverse direction by a left side surface and a right side surface and in a longitudinal direction by a front surface and a rear surface. A first connecting portion is arranged on the base and protrudes from the front surface. A second connecting portion is disposed on the base and protrudes from the rear surface. The second connecting portion is configured for connecting to a first connecting portion of another identically formed track shoe. A plurality of reinforcement ribs are formed on the base spaced apart from each other in the longitudinal direction and extending from at least one of the connecting portions to one of the left side surface and the right side surface in the transverse direction.

In yet another aspect, a track shoe for a track, in particular, a track of a large hydraulic excavator, comprises a plate-shaped base having a substantially rectangular base surface and being defined in a transverse direction by a left side surface and a right side surface and in a longitudinal direction by a front surface and a rear surface. A first connecting portion is disposed on the base and protrudes from the front surface, and a second connecting portion is disposed on the base and protrudes from the rear surface, wherein the second connecting portion is configured for connecting to the first connecting portion of another identically formed track shoe. A cavity extending in the transverse direction is formed in at least one of the first connecting portion and the second connecting portion.

In another aspect, the present disclosure relates to a track for a track vehicle, in particular, a large hydraulic excavator, comprising a plurality of track shoes according to one of the above aspects connected to form the track.

Other features and aspects of the present disclosure will become apparent from the following description and the accompanying drawings.

### BRIEF DESCRIPTION OF THE DRAWINGS

FIG. 1 shows a perspective view of a track shoe in accordance with a first exemplary embodiment;

FIG. 2 shows a perspective view of two track shoes in accordance with an exemplary embodiment connected to each other; and

FIG. 3 shows a side view of the track shoes according to the exemplary embodiment connected to each other.

### DETAILED DESCRIPTION

In the following, a detailed description of exemplary embodiments of the present disclosure will be given. The exemplary embodiments described herein are intended to teach the principles of the present disclosure and enable persons of skill in the arts to implement and use the present disclosure in many different environments and for many different applications. Accordingly, the exemplary embodiments are not intended to limit the scope of protection. Instead, the scope of protection is defined by the appended claims.

The present disclosure may be based at least in part on the realization that a track shoe for a track formed as a cast part or a forged part may improve the durability of the track shoe by increasing the strength of the same. Further, the outer portions of the track shoe can be reinforced by providing a plurality of reinforcement ribs to thereby increase the durability in particular in these portions, thereby also increasing the service life of the track shoe.

In addition, the present disclosure may be based at least in part on the realization that conventional designs allow for a negative rotation of the track links with respect to each other, resulting in an increased wear of the track shoes and damage to other components of the drive system of the machine, for example, a frame on which the track is mounted. Accordingly, the present disclosure is based on the realization that it may be advantageous to limit such a negative rotation.

Finally, the present disclosure is based at least in part on the realization that, due to the high loads during the load transfer between neighboring track shoes, high loads are applied to the running surfaces of the track shoes, which may result in an increased wear or even cracks or deformations. Accordingly, the present disclosure uses running surfaces having a constant width to avoid load concentrations in the track shoes.

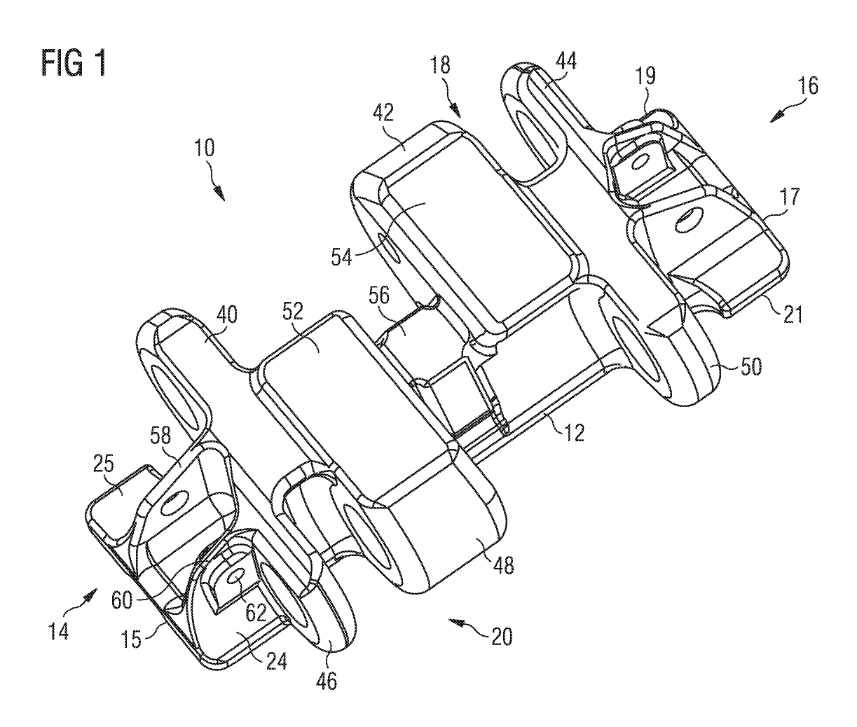

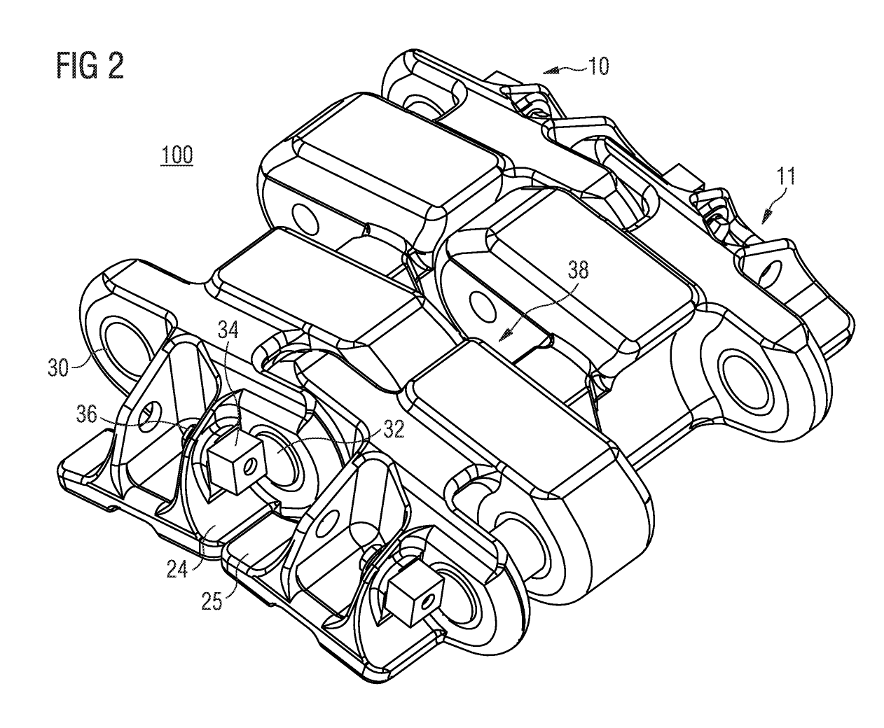

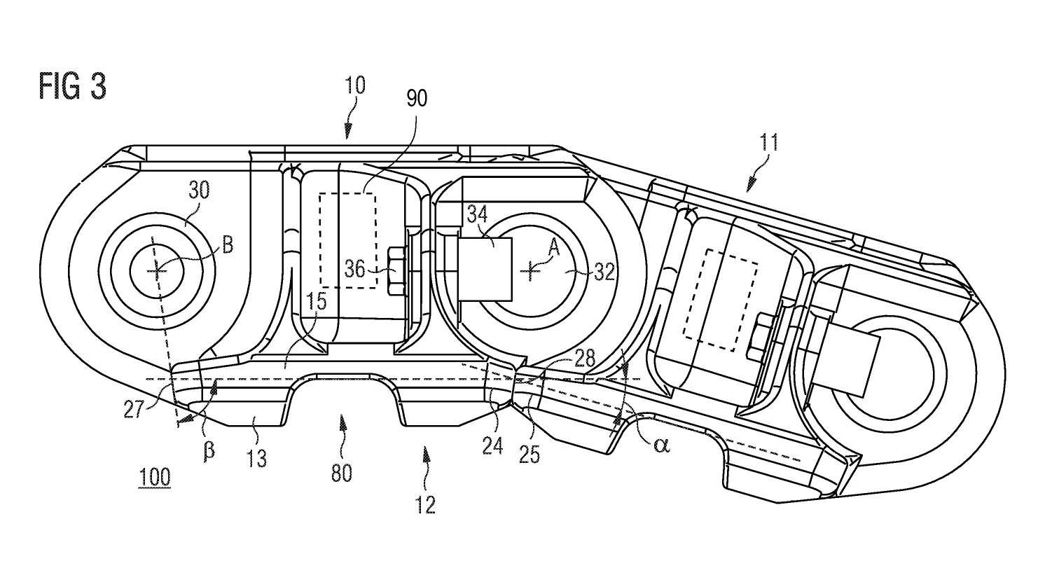

Referring now to the figures, FIG. 1 shows a perspective view of a track shoe in accordance with an exemplary embodiment. FIGS. 2 and 3 show a perspective view and a side view, respectively, of two track shoes of the exemplary embodiment being connected to each other.

As shown in FIG. 1, a track shoe 10 includes a plate-shaped base 12 having a substantially rectangular base or bottom surface 13 (see FIG. 3). Base 12 is defined in a circumferential direction by a left side surface 15, a right side surface 17, a front surface 19, and a rear surface 21. Here, base 12 extends in a transverse direction from a first or left end 14 to a second or right end 16. A first connecting portion 18 and a second connecting portion 20 are disposed on base 12. Connecting portions 18, 20 include several portions, as shown in FIG. 1, first connecting portion 18 including three portions 40, 42, 44 extending from base 12 to the front in a longitudinal direction that is perpendicular to the transverse direction and protruding from front surface 19. On the opposite side, second connecting portion 20 also includes three portions 46, 48, 50 extending in the longitudinal direction and protruding from rear surface 21. It will be appreciated that the terms “left”, “right”, “front”, and “rear” are used herein for the purpose of illustration to designate the respective sides of base 12 or track shoe 10 and are not limiting.

As shown in FIG. 1, portions 40, 42, 44, 46, 48, 50 are formed as projections or noses located on the upper side of base 12 and protruding therefrom to opposite sides in the longitudinal direction. It will be readily appreciated by the skilled person that track shoe 10 is configured such that the two opposite sides in the longitudinal direction are complementary to each other. In other words, second connecting portion 20 disposed on the rear side of track shoe 10 is configured such that it is pivotably connectable to a corresponding first connecting portion 18 of another track shoe. Likewise, first connecting portion 18 on the front side of track shoe 10 is configured such that it may be connected to a corresponding second connecting portion 20 of another track shoe. An exemplary connection is shown in FIG. 2. As shown in FIG. 2, two identical track shoes 10, 11 are connected to each other by pins 32 provided in through holes formed in the portions of connecting portions 18, 20 (FIG. 1) such that they are rotatable with respect to each other about an axis of rotation A (see FIG. 3) defined by the connecting portions or pins 32. A projection 56 is provided at the center of base 12 of each track shoe 10, 11, which forms an engagement portion 38 together with another such projection 56 of a neighboring track shoe. A tooth of a drive sprocket may engage with the engagement portion to drive a track 100 formed by track shoes 10, 11.

It will be readily appreciated by the skilled person that, during use of track 100, track shoes 10, 11 run on corresponding drive sprockets and idlers while being rotated with respect to each other such that, for example, track shoe 11 in FIG. 2 is rotated upwards and base 12 of the same moves away from base 12 of track shoe 10. In the following, this will be referred to as “positive rotation”.

Referring again to FIG. 1, in the exemplary embodiment, portions 40, 42, 44 of first connecting portion 18 are arranged spaced apart from each other in the transverse direction. Here, two portions 42, 44 are provided on one side (the right side) with respect to the center of track shoe 10, while third portion 40 is provided on the other (left) side. Portion 42 closest to the center has a greater width when compared to portions 40, 44. A rectangular running surface 54 is formed on the upper side of portion 42, on which an idler of the track drive rolls during movement of track 100 in a known manner.

Portions 46, 48, 50 of second connecting portion 20 are formed complementary to portions 40, 42, 44 of first connecting portion 18 as mentioned above. That is to say, portion 48 having a greater width and another portion 46 are provided on the left side, while third portion 50 is provided on the right side. A rectangular running surface 52 is formed on the upper side of portion 48. Upon connection to other track shoes, one portion 40 is inserted between portions 46, 48, while the associated portion 50 is inserted in portions 42, 44. Next, two pins 32 (see FIG. 2) are inserted from the outside into the through holes of the respective portions and fixed, which will be described in more detail below. In order to allow for a smooth rotation of the track shoes with respect to each other, the ends of portions 40, 42, 44, 46, 48, 50 are rounded-off, while corresponding recesses are formed in the rear sides of the same. The upper sides of connecting portions 40, 44, 46, 50 are recessed with respect to the upper side of portions 42, 48 having running surfaces 52, 54 such that, during movement of the track 100, they do not come into contact with the idlers.

As described above, during movement of track 100 around the idlers of the track drive, a positive rotation occurs between the same. In other words, the opposing front surfaces 19 and rear surfaces 21 of adjacent track shoes 10, 11 move away from each other. However, a rotation in an opposite direction may occur in regions between the idlers and supporting rollers (herein also referred to as “negative rotation”), during which front surface 19 and rear surface 21 of neighboring track shoes 10, 11 approach each other. This is shown, for example, in FIG. 2. As outlined above, the abutment of the surfaces of the track shoes 10 may result in an increased wear and damage to a frame member or the like which is disposed above the track shoes. In order to suppress this, front surface 19 and rear surface 21 of track shoe 10 include a front stopper 25 and a rear stopper 24, respectively, formed such that, upon rotation of track shoe 11 connected to track shoe 10, for example, rear stopper 24 of track shoe 10 abuts against front stopper 25 of track shoe 11 after rotation by a predetermined angle α (see FIG. 3), which is shown in more detail in FIG. 3.

In the exemplary embodiment, stoppers 24, 25 are each formed on both ends 14, 16 of base 12 in the transverse direction, respectively. Here, stoppers 24, 25 have predetermined positions with respect to axes of rotation A, B defined by the respective connecting portions 18, 20, which predetermined positions result in abutment of stoppers 24, 25 after a negative rotation by the predetermined angle α.

For example, front stopper 25 and rear stopper 24 each include a front stopper surface 27 and a rear stopper surface 28, each disposed at an angle β of less than 90° with respect to base surface 13 (the plane defined by base surface 13), as shown in FIG. 3. For example, the angle β is selected such that it is equal to 90° minus the amount of one half of the predetermined angle α at which track shoes 10, 11 abut against each other. In this manner, it can be assured that, when stoppers 24, 25 abut against each other, a plane contact between corresponding stopper surfaces 27, 28 is obtained, resulting in reduced wear and reliably limiting the negative rotation. In some embodiments, stoppers 24, 25 may be formed such that an imaginary line connecting the axis of rotation A or the axis of rotation B to rear stopper 24 or front stopper 25 and perpendicular to axis of rotation A or B intersects the normal of base surface 13 at an angle of α/2 that is substantially half the predetermined angle to which the negative rotation of the track shoes with respect to each other is to be limited.

As described above, stoppers 24, 25 are formed on ends 14, 16 of base 12, which may be formed as a widened end portion of base 12 with respect to the longitudinal direction. In order to reinforce these end portions, as shown in FIG. 1, reinforcement ribs 58, 60 are provided, which reinforcement ribs 58, 60 extend spaced apart from each other from the outer connecting portions 40, 46 or 44, 50 to the left side surface 15 or the right side surface 17 in the transverse direction. As shown in FIG. 1, the reinforcement ribs are formed such that they extend upwards from the left side surface 15 and the right side surface 17 and then extend inwards to merge with an upper side of portions 40, 46, 44, 50. A mounting portion 62 for a fixing bolt 36 for fixing a connecting pin 32 received in first or second connecting portion 18, 20 is provided on one of the reinforcement ribs 60 (see FIGS. 2 and 3).

As shown, for example, in FIG. 3, a groove 80 extending in the transverse direction is formed in the base surface of base 12. The groove 80 extends from the left side surface 15 to the right side surface 17. It should be understood, however, that in other embodiments groove 80 may be omitted.

It will be appreciated that numerous modifications and alterations may be made to the disclosed track shoe without departing from the scope of protection.

For example, in the embodiments shown in the figures, stoppers 24, 25 are provided on the outer ends of base 12 of the track shoe. In other embodiments, however, stoppers 24, 25 may be provided at different positions in the transverse direction, for example, at the center or the like. Further, in other embodiments, only a single stopper may be provided on the front side and the rear side, respectively, to limit a negative rotation. In other embodiments, more than two stoppers may be provided on each side. Further, more than two reinforcement ribs 58, 60 may be provided on the ends 14, 16 of base 12 to reinforce the same.

The predetermined angle α at which negative rotation between two track shoes is limited may be appropriately determined in advance depending on the application. For example, the angle α may be less than 25°, for example, between around 5° and around 25°, in particular, between 10° and 20°, for example, 15° or less.

Although the present embodiment has been described as a one-piece track shoe, in other embodiments, track shoe 10 may be formed from several parts. For example, connecting portions 18, 20 may be connected to base 12 in an appropriate manner. Further, the running surfaces provided on portions 48, 42 do not necessarily have to be rectangular, but they also may be Z-shaped or have any other appropriate shape. Further, the number of portions 40, 42, 44 and 46, 48, 50, respectively, of connecting portions 18, 20 is not limited to three and may be more or less in other embodiments. Further, track shoe 10 does not necessarily have to be symmetric, i.e., different numbers of portions of connecting portions 18, 20 may be provided on the front and the rear.

In some embodiments, a cavity 90 may be formed in at least one of first connecting portion 18 and second connecting portion 20, as shown by a dashed line in FIG. 3. Cavity 90 may extend in the transverse direction and may be opened in a side surface of one of portions 40, 42, 44, 46, 48, 50 of connecting portions 18, 20. For example, a pair of cavities may be formed in portions 40 and 50 (see FIG. 1). It will be readily appreciated that in some embodiments cavity 90 may only be formed in one of portions 40, 50. Likewise, cavity 90 may extend into portions 42, 48 of first and second connecting portions 18, 20, if desired. In some embodiments, cavity 90 may even extend into projection 56 and/or penetrate track shoe 10, i.e., extend from the outer side surface of portion 40 to the outer side surface of portion 50. It will be readily appreciated that cavity 90 may have any appropriate cross section in the direction perpendicular to the transverse direction, and that the cross section of cavity 90 may not be constant as it extends in the transverse direction.

With the provision of cavity 90, it becomes possible to reduce the weight of track shoe 10, which is advantageous both during operation of the associated machine and during transport of track shoe 10. For example, a track shoe for use with a large hydraulic excavator may have a total weight of up to 800 kg, and the provision of cavity 90 may reduce the weight of track shoe 10 by approximately 5%.

### INDUSTRIAL APPLICABILITY

The industrial applicability of the systems and methods disclosed herein will become readily apparent from the above discussion. An exemplary machine that is suitable for the disclosure is a large hydraulic excavator having a track drive. It will be understood, however, that the present disclosure may be applied to a number of different machines having such a track drive.

A method for preventing a negative rotation between two track shoes of a track includes providing stoppers on opposite sides of a base of each track shoe, the stoppers being formed such that, upon rotation of the track shoes with respect to each other, a stopper of one plate abuts against an opposing stopper of the neighboring plate at a predetermined angle to limit the negative rotation. The method may further include providing reinforcement ribs that extend outwards on ends of the base of each track shoe to reinforce said ends. Further, the method may include providing widened connecting portions in the vicinity of a center of the base of the track shoe, where a substantially rectangular running surface is formed on the same.

It will be readily appreciated that the above description provides examples for the disclosed system and methods. It is also contemplated, however, that other implementations of the disclosure may differ in detail from the above examples. All references to the disclosure or to examples of the same are intended to refer to the particular example discussed at that point and are not intended to limit the scope of the disclosure in general. All methods disclosed herein may be performed in any appropriate order, unless otherwise indicated herein or contradicted by context.

Accordingly, this disclosure includes all modifications and equivalents of the subject-matter of the appended claims to the extent allowed by law. Further, any arbitrary combination of the above-described elements in all possible variations is encompassed by the disclosure, unless otherwise indicated herein or contradicted by context.

Although preferred embodiments of the disclosure have been described herein, improvements and modifications may be included without departing from the scope of the following claims.

1. A track shoe for a track, comprising:
a plate-shaped base having a substantially rectangular base surface and being defined in a circumferential direction by a left side surface, a right side surface, a front surface and a rear surface;
a first connecting portion disposed on the base and protruding from the front surface; and
a second connecting portion disposed on the base and protruding from the rear surface, wherein the second connecting portion is configured for connecting to the first connecting portion of another identically formed track shoe such that said other track shoe is rotatable about an axis of rotation with respect to the track shoe,
wherein the front surface and the rear surface include a front stopper and a rear stopper, respectively, configured such that, upon rotation, the rear stopper of the track shoe abuts against the front stopper of the other track shoe at a predetermined angle to limit the rotation.

2. The track shoe according to claim 1, wherein the front stopper and the rear stopper include a front stopper surface and a rear stopper surface, respectively, disposed at an angle of less than 90° with respect to the base surface.

3. The track shoe according to claim 2, wherein the angle is equal to 90° minus the amount of half of the predetermined angle.

4. The track shoe according to claim 1, wherein an imaginary connecting line from the axis of rotation to the rear stopper and extending perpendicular to the axis of rotation intersects the normal of the base surface at an angle that is substantially half the predetermined angle.

5. A track shoe for a crawler track, comprising:
a plate-shaped base having a substantially rectangular base surface and being defined in a transverse direction by a left side surface and a right side surface and in a longitudinal direction by a front surface and a rear surface;
a first connecting portion disposed on the base and protruding from the front surface; and
a second connecting portion disposed on the base and protruding from the rear surface, wherein the second connecting portion is configured for connecting to the first connecting portion of another identically formed track shoe,
wherein the front surface and the rear surface include a front stopper having a front stopper surface and a rear stopper having a rear stopper surface, respectively, wherein each of the stopper surfaces is disposed at an angle of less than 90° with respect to the base surface.

6. The track shoe according to claim 5, wherein the front stopper and the rear stopper are formed on the front surface and the rear surface on opposite sides of the track shoe in a transverse direction.

7. The track shoe according to claim 6, wherein each of the ends is formed as a widened portion of the base in a longitudinal direction that is perpendicular to the transverse direction.

8. The track shoe according to claim 6, wherein respective pairs of reinforcement ribs that extend outwards in the transverse direction are formed on upper sides of the ends, the reinforcement ribs extending to a corresponding one of the left side surface and the right side surface.

9. The track shoe according to claim 8, wherein a respective one of the reinforcement ribs includes a mounting portion for a fixing bolt for fixing a connecting pin received in the first or second connecting portion.

10. The track shoe according to claim 5, wherein the first connecting portion and the second connecting portion are complementary to each other and each include three laterally spaced portions, wherein a respective one of the portions that is closest to a center is widened and has a substantially rectangular running surface on its upper side.

11. The track shoe according to claim 1, wherein the track shoe is formed as a cast part.

12. The track shoe according to claim 1, wherein a transverse groove is formed in the base surface of the base, the groove extending from the left side surface to the right side surface.

13. The track shoe according to claim 1, wherein the predetermined angle is between about 5° and about 25°.

14. A track shoe for a track, comprising:
a plate-shaped base having a substantially rectangular base surface and being defined in a transverse direction by a left side surface and a right side surface and in a longitudinal direction by a front surface and a rear surface;
a first connecting portion disposed on the base and protruding from the front surface; and
a second connecting portion disposed on the base and protruding from the rear surface, wherein the second connecting portion is configured for connecting to the first connecting portion of another identically formed track shoe,
wherein a plurality of reinforcement ribs are formed on the base, the plurality of reinforcement ribs being spaced from each other in the longitudinal direction and extending in the transverse direction from at least one of the connecting portions to one of the left side surface and the right side surface.

15. The track shoe according to claim 14, wherein the reinforcement ribs extend upwards from the respective side surfaces and inwards to the connecting portions to merge with an upper surface of the same.

16. The track shoe according to claim 14, wherein one reinforcement rib includes a mounting portion for a fixing bolt for fixing a pin received in the connecting portions.

17. The track shoe according to claim 14, wherein the plurality of reinforcement ribs are provided on both sides in the transverse direction.

18. (canceled)

19. (canceled)

20. (canceled)

21. (canceled)

22. (canceled)

23. A track for a track vehicle, in particular, comprising:
a plurality of track shoes connected to each other to form a crawler track, each of the plurality of track shoes comprising:
a plate-shaped base having a substantially rectangular base surface and being defined in a circumferential direction by a left side surface, a right side surface, a front surface and a rear surface:
a first connecting portion disposed on the base and protruding from the front surface; and
a second connecting portion disposed on the base and protruding from the rear surface, wherein the second connecting portion is configured for connecting to the first connecting portion of another identically formed track shoe such that said other track shoe is rotatable about an axis of rotation with respect to the track shoe,
wherein the front surface and the rear surface include a front stopper and a rear stopper, respectively, configured such that, upon rotation, the rear stopper of the track shoe abuts against the front stopper of the other track shoe at a predetermined angle to limit the rotation.

24. The track according to claim 1, wherein the track vehicle is a large hydraulic excavator.

25. The track according to claim 14, wherein the track vehicle is a large hydraulic excavator.
